(19) United States
(12) Patent Application Publication
(10) Pub. No.: US 2007/0248311 A1
(43) Pub. Date: Oct. 25, 2007

(54) System and method for transferring data between electronic data storage devices

(76) Inventors: Nathaniel Wice, New York, NY (US); Joshua Hochman, Brooklyn, NY (US)

Correspondence Address: THELEN REID BROWN RAYSMAN & STEINER LLP, PO BOX 1510, 875 Third Avenue, 8th Floor, NEW YORK, NY, 10150-1510, US

(21) Appl. No.: 11/394,523

(22) Filed: Mar. 31, 2006

(51) Int. Cl. H04N 5/93

(52) U.S. Cl. 386/52

(57) ABSTRACT

Method, device, and system for transferring data from one portable media player to another. Small, portable devices that store and play back text, music, video, and/or other types of media have proliferated. Transferring data between such devices is often inconvenient, however, because it typically requires connecting both devices to a personal computer. Embodiments of the invention provide methods, devices, and systems for copying data from one media player to another without the use of a personal computer. Such embodiments may comprise, for example, a portable device commensurate in size to a media player or smaller. Such a portable device may be connected to a source media player and a target media player and may copy some or all files from the source to the target. In some embodiments of the invention, the user can select specific files for copying.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent files or records, but otherwise reserves all copyrights whatsoever.

### BACKGROUND

The invention relates to the transfer of data from one portable electronic data storage device to another. More specifically, it relates to portable devices that may be used to copy media files from one portable electronic storage device, such as a portable media player, to another without use of a personal computer and to methods of copying media files from one personal media player to another involving the use of such a portable device.

Mainstream consumer acceptance of the personal computer has spawned overlapping categories of portable devices that exchange data with the computer and function as accessories to it. For example, media players, such as the iPod® from Apple Computer, Inc., can store and play, e.g., digitized text, audio, and/or video, stored as files on the devices, while being small enough to fit in the hand, or even smaller. (Such digitized text, audio, and/or video content may be referred to as “media content,” and commonly is stored as entities referred to as “files.” A file containing media content may be referred to as a “media file.”) Connecting a personal media player to a personal computer enables a user to add, manipulate, and retrieve data from the player. Some players have the additional capability of acting as general-purpose storage media (for example, acting as removable, external hard drives) in addition to their media-related capabilities.

A persistent problem, however, is that media players typically require connection to a personal computer to backup or otherwise copy data. In the case of the iPod®, moreover, access to some stored data is not available even with connection to a personal computer, because the supplied software does not copy media files from a player to a personal computer. Although workarounds exist using software from third parties, these solutions nonetheless require use of a personal computer for commonly-desired activities, such as backups and the synchronization of multiple players.

The need to use a personal computer when transferring files to or from a media player is an inconvenience to their users. People are likely to carry their media players with them casually because the players are small and lightweight. They are thus likely to have their media players with them in social environments and locations in which they are unlikely to have access to personal computers, even portable ones. But those circumstances are precisely those in which it is most likely that users will want to transfer files from one media player to another. It is thus desirable to enable users to copy one or more files directly from one media player to another without reliance on a personal computer and to do so without impairing the convenience of carrying a media player.

### BRIEF SUMMARY

According to an embodiment of the invention, a method is provided for copying data from one portable electronic data storage device to another. The method comprises coupling a source media player to a portable transfer device, the source media player comprising a first data storage medium upon which data is stored in a file system and the stored data comprising at least one file that comprises digitized media data, coupling a destination media player to the transfer device while the source media player is coupled to the transfer device, the destination media player comprising a second data storage medium, selecting one or more media files that are stored on the source media player, each media file comprising digitized media data, and, using the transfer device, copying the one or more selected media files from the source media player to the destination media player.

In an embodiment of the invention, the preceding method comprises formatting the data storage medium of the destination player. In a further embodiment of the invention, formatting the data storage medium of the destination player comprises creating one or more additional files and/or directories on the destination media player that are required for the proper functioning of the destination media player.

In an embodiment of the invention, the stored data of the source media player comprises additional data associated with one or more media files, such that, for at least one media file that is associated with the additional data, some or all of the additional data is stored externally to the associated media file. In an embodiment of the invention, the additional data comprises metadata. In another embodiment of the invention, copying one or more selected files from the source media player to the destination media player comprises copying to the destination media player at least some of the additional data associated with one or more of the selected media files.

In a further embodiment of the invention, copying comprises copying only media data, additional data that is associated with media data, and file system data.

According to an embodiment of the invention, a portable device assembly is provided that is capable of copying data from one portable electronic data storage device to another. The device assembly comprises a central processing unit, a source interface coupled with the central processing unit and configured to couple with a source media player comprising a data storage medium upon which data is stored in a file system, the stored data comprising at least one media file that comprises digitized media data, a destination interface coupled with the central processing unit and configured to couple with a destination media player; and a data storage medium coupled to the central processing unit, wherein the central processing unit is programmed to select one or more media files stored on the source media player and comprising digitized media data and to copy the one or more selected media files from the source media player to the destination media player, and wherein the portable transfer device is of a size commensurate with or smaller than the source media player.

In an embodiment of the invention, the central processing unit is programmed to format the data storage medium of the destination media player. In a further embodiment of the invention, formatting the data storage medium of the destination player comprises creating one or more additional files and/or directories on the destination media player that are required for the proper functioning of the destination media player.

In an embodiment of the invention, the stored data of the source media player comprises additional data associated with one or more media files, such that, for at least one media file that is associated with the additional data, some or all of the additional data is stored externally to the associated media file, and the central processing unit is programmed to store on the destination media player some or all of the additional data that is associated with one or more of the copied files. In a further embodiment of the invention, the central processing unit is programmed to copy only media data, additional data that is associated with media data, and file system data.

In an embodiment of the invention, the device assembly, at least one of the source interface and the destination interface is a USB 2.0 port. In an embodiment of the invention, at least one of the source interface and the destination interface is a FireWire® port.

In an embodiment of the invention, at least one of the source interface and the destination interface comprises a connector that is capable of coupling with an interface adapter, the interface adapter is capable of coupling a media player to the device, and the device is capable of being coupled at different times to a plurality of media players having mutually incompatible interfaces by coupling an adapter corresponding to an appropriate interface to the connector.

According to an embodiment of the invention, a system is provided for copying electronic data comprising digitized media data from a source media player to a destination media player, the system comprising a portable transfer device for copying electronic data comprising digitized media data from a source media player to a destination media player, comprising a central processing unit, a source interface coupled with the central processing unit and capable of coupling with a source media player comprising a data storage medium upon which data is stored, the stored data comprising at least one file that comprises digitized media data, a destination interface coupled with the central processing unit and capable of coupling with a destination media player, and a data storage medium coupled to the central processing unit; and at least one adapter capable of coupling to the source interface and/or the destination interface, such that the source media player and/or the destination media player is capable of coupling to the transfer device when the adapter is coupled to the corresponding interface; wherein the central processing unit is programmed to select one or more media files stored on the source media player and comprising digitized media data and to copy the one or more selected media files from the source media player to the destination media player.

### BRIEF DESCRIPTION OF THE DRAWINGS

The invention is illustrated in the figures of the accompanying drawings, which are meant to be exemplary and not limiting, and in which like references are intended to refer to like or corresponding things.

FIG. 1 depicts an exemplary electronic data storage device, according to the prior art, suitable for use with an embodiment of the invention.

FIG. 2 depicts a device for transferring data between electronic data storage devices according to an embodiment of the invention.

FIG. 3 depicts the main components of a device for transferring data between electronic data storage devices according to an embodiment of the invention.

FIG. 4 depicts the architecture of a software platform such as may be implemented in an embodiment of the invention.

FIG. 5 depicts initialization of a device for transferring data between electronic data storage devices according to an embodiment of the invention.

FIG. 6 depicts the contents of a screen display that an embodiment of the invention may present to a user at startup.

FIG. 7 depicts transferring data from a first electronic data storage device to a second electronic data storage device according to an embodiment of the invention.

FIG. 8 depicts the contents of a screen display that an embodiment of the invention may present to a user upon connection to a first electronic data storage device.

FIG. 9 depicts the contents of a screen display that an embodiment of the invention may present to a user upon connection to a second electronic data storage device.

FIG. 10 depicts a “clone/clone until full” action according to an embodiment of the invention.

FIG. 11 depicts the contents of a screen display that a device according to an embodiment of the invention may present to a user while transferring data.

FIG. 12 depicts the contents of a screen display that a device according to an embodiment of the invention may present to a user upon successful completion of a data transfer.

FIG. 13 depicts a “copy all/copy until full” action according to an embodiment of the invention.

FIG. 14 depicts a “copy some” action according to an embodiment of the invention.

FIGS. 15-18 depict the contents of the display that may be presented in an embodiment of the invention in connection with selection of files to be copied.

### DETAILED DESCRIPTION OF THE PREFERRED EMBODIMENTS

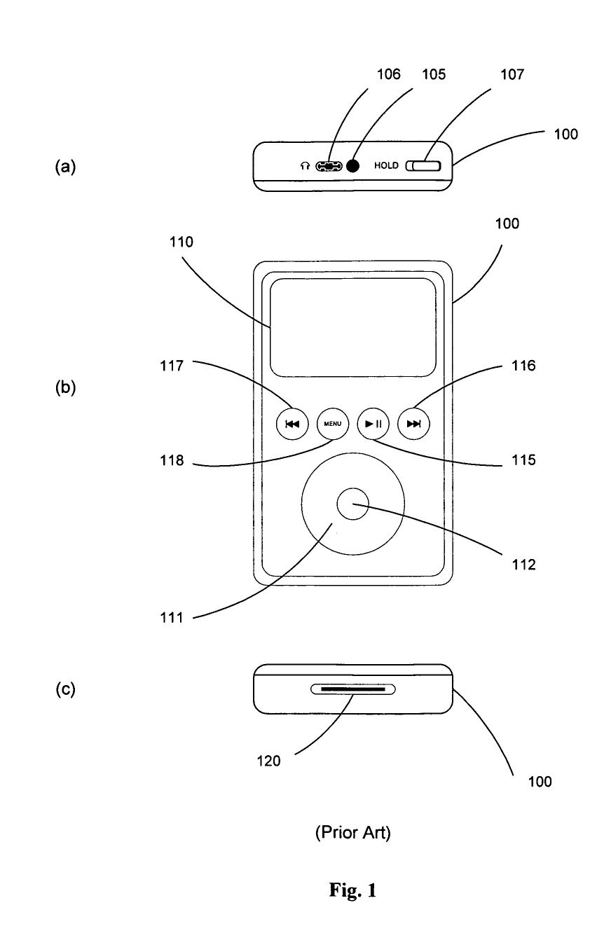

The invention is usable with portable electronic data storage devices, and is described in connection with portable media players such as are well known in the relevant arts. One such device, for example, is the iPod® from Apple Computer, Inc. FIG. 1 depicts one iPod® model to illustrate features common to portable electronic data storage devices.

FIG. 1(a) depicts an iPod® 100 from above. The top contains a jack 105 for connecting a pair of stereo headphones (not pictured) or other sound output device. Another connector 106 allows a remote control to be used with the iPod® 100. A slide switch 107 allows deactivation of the controls of the iPod® 100 to prevent accidental activation of a control, for example, while the user is exercising.

FIG. 1(b) depicts the iPod® 100 from the front. An LCD display 110 presents information in connection with use of the iPod® 100. Displayed information may include, for example, a menu of commands or categories of commands, a menu of music and/or categories of music, a menu of settings and/or categories of setting, and/or information about a song, album, or playlist.

When multiple items appear in the display 110, e.g., in a list (such as, for example, a menu or a list of songs), a touch-sensitive scroll wheel 111 allows selection among them. If more items are available for selection than will fit in the display 110, the scroll wheel 111 may also be used to scroll forward and backward among the items. The scroll wheel 111 may also have other functions: for example, depending on the context in which it is used, the scroll wheel 111 may raise or lower the song volume, or it may be used to move forward or backwards within a single song. The selection button 112 is used to indicate choice of the currently selected item.

Additional buttons 115-117 are used to control playback of songs. The play/pause button 115 is used to start and pause playback of the currently selected song. The fast forward button 116 is used to skip the remainder of the currently-playing song and advance to the next song. The reverse button 117 is used to return to the beginning of the currently-playing song, or, if the currently-playing song is already at its beginning, the reverse button 117 is used to return to the beginning of the previous song.

The “Menu” button 118 is used to cause a menu to appear on the display 110. Typically, the menus of the iPod® 100 are organized hierarchically, and the “Menu” button 118, the scroll wheel 111, and the selection button 112 are used to traverse the hierarchy. When a menu appears in the display 110, the scroll wheel 111 is used to highlight the desired command, and then the selection button 112 selects the highlighted command, which often leads to display of a submenu. The “Menu” button 118, conversely, is used to move from a submenu to a higher-level menu.

FIG. 1(c) depicts the iPod® 100 from below. The data connector 120 has multiple functions. With the appropriate cable (not pictured), it may be used to connect the iPod® 100 to a personal computer (not pictured). Depending on the cable used and the capabilities of the associated computer, the iPod® 100 may be connected to the personal computer's Universal Serial Bus (“USB”) port, USB 2.0 port, or FireWire® port (also known as an IEEE 1394 or i.Link® port). Other devices, such as docking stations and external powered speakers, also use the data connector 120.

The iPod® 100 is powered by an internal, rechargeable battery (not pictured) and the data connector 120 is used to recharge the battery. Both USB and FireWire® interfaces make electrical power available, and, when connected to a personal computer, the iPod® 100 may use this available power to recharge itself. A dedicated external charger may provide power to the iPod® 100 using the same mechanism. Conversely, when attached to another device via a USB or FireWire® interface, the iPod may provide electrical power to that device.

Other media players are available from other manufacturers, such as the Zen™ line of devices from Creative Technology Ltd. and the Sansa™ and other lines of media players from SanDisk, Inc. Additionally, other types of device include the functionality provided by media players: for example, the ROKR™ cellular phone from Motorola is capable of downloading music from the Apple iTunes® store, storing it, and playing it back in the same manner as other media players.

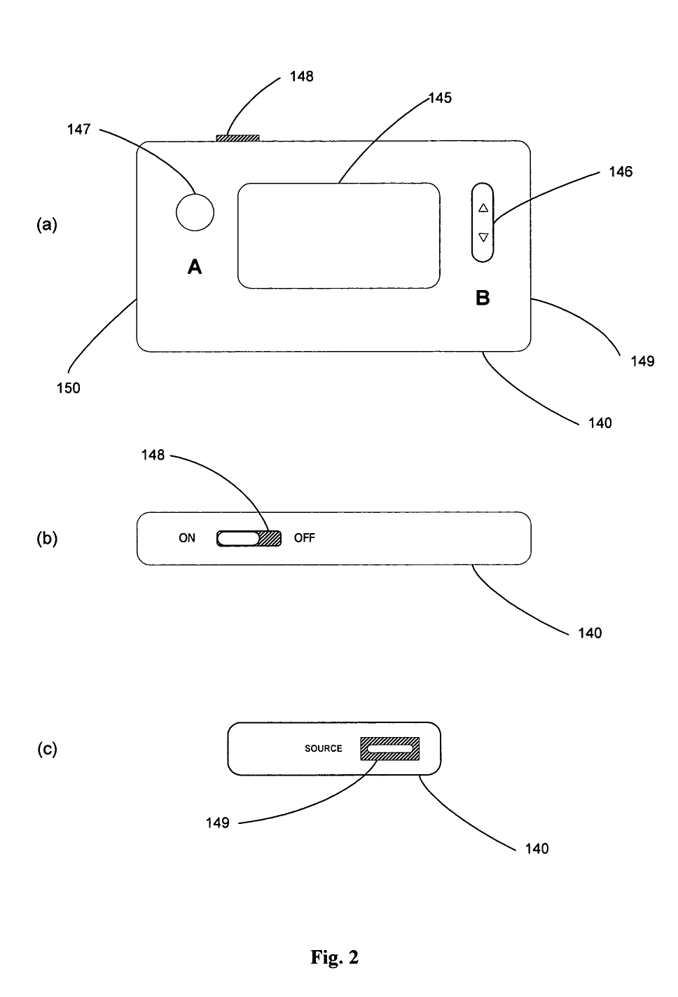

FIG. 2 depicts a device 140 (sometimes referred to herein as a “transfer device”) for transferring data according to an embodiment of the invention. FIG. 2(a) depicts the device 140 from the front. In the depicted embodiment, the device 140 comprises a display 145, which may comprise, e.g., a multi-line LCD display unit, by which the device presents information. A navigation switch 146 allows scrolling forward and backward through information presented on the display 145 and/or highlighting one or more items presented on the display, e.g., in a list. A push button 147 allows selection of a displayed or highlighted item.

As depicted in FIG. 2, the device 140 comprises a slide switch 148 used to turn the device 140 on and off. FIG. 2(b) depicts the device 140 from the top and provides another view of the slide switch 148.

FIG. 2(c) depicts the device 140 from one side, illustrating a source USB 2.0 port 149. A source media player (not pictured) can be connected to the source USB 2.0 port 149 for transferring data from the source media player. On the opposite side of the device 140, a destination USB 2.0 port 150 is provided (FIG. 2(a)), and a destination media player (not pictured) can be connected to the destination USB 2.0 port 150 for transferring data to the destination media player.

An embodiment of the invention may comprise ports other than or in addition to USB 2.0 ports. For example, the FireWire® interface is also commonly used for storage devices, and so a device 140 may comprise one or more FireWire® ports for connecting to the source and/or destination storage devices. For another example, an embodiment of the invention may comprise a port or ports corresponding to a proprietary interface used in one or more models of storage devices. One such proprietary interface is the 30-pin connector built into some models of the iPod®.

It may be possible in an embodiment of the invention to change the interface used by a transfer device to connect to a portable media player. For example, an embodiment may comprise a device 140 that comprises one or more USB 2.0 ports, as described above, and one or more USB 2.0-compatible adapters (not pictured) that provide, e.g., a FireWire® interface to an external device. An embodiment of the invention may comprise a plurality of adapters, each adapter corresponding to one or more standard and/or proprietary interfaces that may be comprised by a media player.

Instead of or in addition to one or more of the USB 2.0 ports described above, an embodiment of the invention may comprise one or more connectors that may be used with multiple types of interfaces. The particular type of interface provided by a connector is, in such an embodiment, determined by the particular adapter that is connected with that connector.

In an embodiment of the invention, the device 140 is comprised by an assembly that also comprises one or more adapters capable of coupling the device 140 to one or more interfaces used by media players.

Instead of or in addition to one or more ports, a device according to an embodiment of the invention may comprise one or more cables that provide one or more interfaces. In such an embodiment, a cable extending from the device may plug into a port provided by a media player. In an embodiment of the invention, the device may comprise one or more connectors that plug into a port provided by a media player.

An embodiment of the invention may, instead of or in addition to the ports described above, support one or more wireless means for connecting to the source and/or destination storage devices. For example, the device 140 may comprise an optical transmitter/receiver (not pictured) comprising, e.g., an infrared light-emitting diode (“LED”) and a photodetector. As another example, the device may comprise appropriate hardware to support the Bluetooth® wireless technology, which is a well-known technology for, e.g., connecting electronic devices to one another.

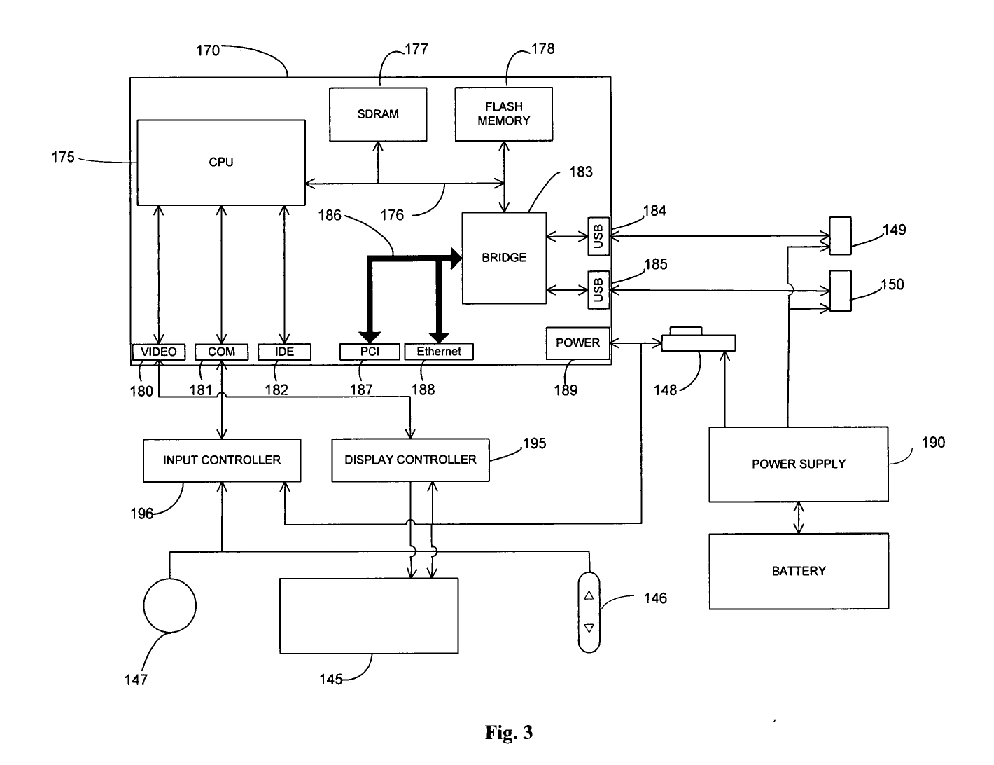

The subsystems of a device 140 according to an embodiment of the invention are depicted in FIG. 3. As depicted, the device 140 comprises a computer on module (“COM”) 170, which is a complete digital computer that has been designed to be small and to consume relatively little power. COMs are well known in the art and are available from numerous commercial suppliers. An example of a commercially available COM suitable for use in a device 140 according to an embodiment of the invention is the X-board™, from Kontron Embedded Modules GmbH. The physical dimensions of the X-board are 68 mm×49 mm, with a height of approximately 6 mm, convenient for including the X-board in a portable device. Reference to the X-board is for illustrative purposes only, however, and one skilled in the art will appreciate that other devices are suitable as well.

The COM 170 comprises subsystems and functions typical of digital computers. A CPU 175, such as is provided by, e.g., Intel, AMD, Freescale, or other manufacturer, executes stored instructions, manipulates data, and controls the other functions of the COM 170. The CPU 175 has access via a bus 176 to volatile storage 177 (e.g., SDRAM) and non-volatile storage 178 (e.g., flash memory).

The COM 170 has one or more interfaces to external devices. For example, as depicted in FIG. 3, the COM comprises a video interface 180, a serial port 181 (commonly called a “COM” port, but this usage will be avoided to avoid confusion with the other use of “COM”), and an IDE port 182. A COM 170 may provide other interfaces via a bridge 183 connected to the bus 176. For example, as depicted in FIG. 3, the bridge 183 provides USB 2.0 interfaces 184, 185 (connected to the source USB 2.0 port 149 and the destination USB 2.0 port 150 respectively) and a PCI bus 186 and associated interface 187. An Ethernet interface 188 is further provided via the PCI bus 186.

The various components of the COM 170 receive electrical power from an onboard power supply 189. In the depicted device 140, the onboard power supply 189 accepts a single external power connection at +3.3 volts from the external power supply 190 and then converts this supplied voltage to the various levels that the respective components of the COM 170 may require.

The description of the COM 170 herein is intended to be illustrative and not limiting. There may or may not be a one-to-one correspondence between the physical components of the described COM 170 and the subsystems described herein. A COM 170 may comprise subsystems, functions, and/or interfaces other than and/or in addition to those described herein while remaining suitable for use with an embodiment of the invention. Further, a device 140 according to an embodiment of the invention may comprise a COM 170 that comprises subsystems and/or structures organized differently from those depicted in FIG. 3. An embodiment of the invention may also comprise a component other than a COM, such as, e.g., one or more dedicated and/or standard integrated circuits, e.g., field programmable gate array (“FPGA”) circuits, among others, such as are well known in the relevant arts.

The external power supply 190, which may be contained within the device 140, regulates and/or distributes electric power from a battery 190, which may also be contained within the device 140. Depending on the embodiment of the invention, the battery 190 may comprise, e.g., one or more replaceable single-use batteries and/or one or more rechargeable power sources such as a lithium-ion battery pack.

In connection with an embodiment of the invention, the device 140 may be powered from an external source. For example, the device 140 may draw power from one or more external devices (not pictured) attached to one or more USB 2.0 ports 149, 150. In an connection with an embodiment of the invention, the device 140 may comprise an additional connector (not pictured) through which electric power may be supplied, e.g., from an adapter connected to mains power. A device 140 that comprises a rechargeable power source may similarly draw external power to recharge the power source, and such a device may comprise a power supply 190 that comprises circuitry to recharge the power source using electric power from the external source.

Depending on the capabilities of the COM 170 and the display 145, the display 145 may connect directly to the video interface 180 of the COM or, as depicted in FIG. 3, through a display controller 195. In connection with another embodiment of the invention, the display 145 and/or the display controller 195 may connect to an interface other than the video interface 180. For example, the serial interface 181, the interface 187 to the PCI bus 186, an additional USB 2.0 port (not pictured), or, if provided by the COM 170, another interface may be used, depending on the nature of the COM 170, the display controller 195 and/or display 145.

An input controller 196 may be used to make input from the navigation switch 146 and/or the push button 197 available to the COM 170, e.g., by connecting to the serial port 181 as depicted in FIG. 3. In connection with another embodiment of the invention, the input controller 196 may connect to an interface other than the serial port 181. For example, the interface 187 to the PCI bus 186, an additional USB 2.0 port (not pictured), or, if provided by the COM 170, another interface (not pictured) may be used depending on the nature of the COM 170 and/or the input controller 196.

In connection with an embodiment of the invention, the slide switch 148 is used to turn the device 140 on, e.g., by establishing a connection between the power supply 190 and the COM 170, or off, e.g., by interrupting the connection between the power supply 190 and the COM 170.

It is well known that many portable media players comprise components comparable to the components of the device 140 described herein. For example, in many versions, the iPod® comprises a central processing unit, data storage media, a rechargeable battery, a display unit, input devices, a power supply, and multiple interfaces and connectors in a form factor roughly the size of a deck of playing cards. For example, a model of video iPod® with a 60 GB disk drive has dimensions of 4.1×2.4×0.55 inches, and weighs 5.5 ounces. Because of this correspondence, the device 140 may itself be of size comparable to a media player, if not smaller.

The preceding description of a device 140 is meant to be illustrative and not limiting. It will be apparent to one skilled in the relevant arts that other components, systems, and/or configurations may suitably be used in connection with an embodiment of the invention.

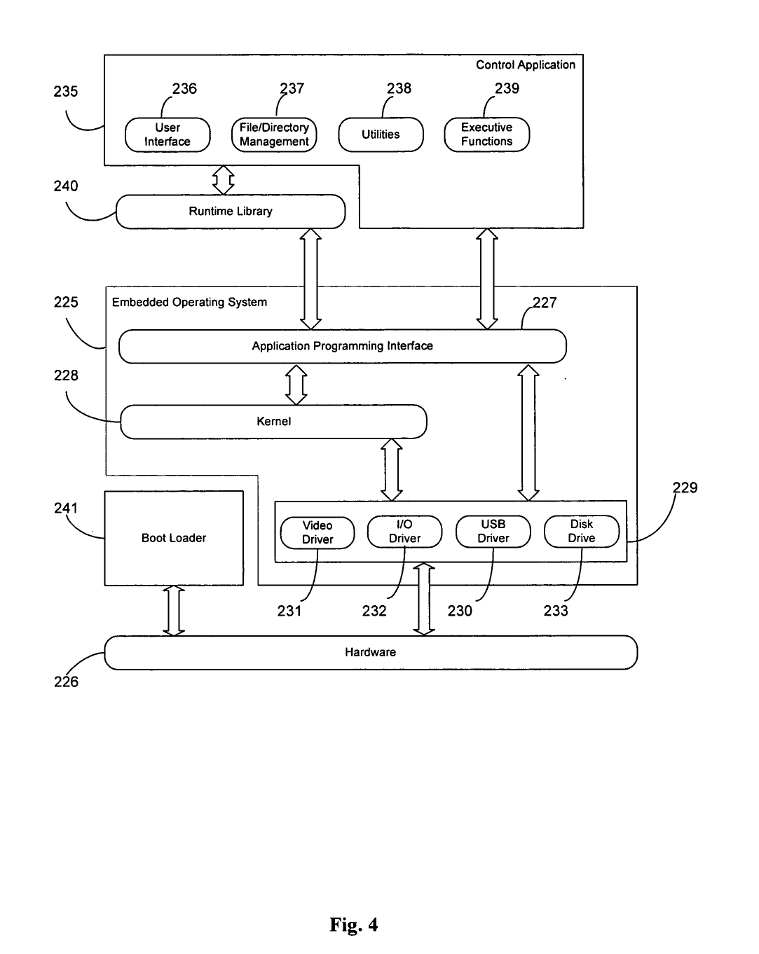

In an embodiment of the invention, the operation of the device 140 is driven by software, which may comprise instructions for the CPU 175 and/or data for manipulation by the CPU 175. FIG. 4 depicts schematically a software architecture 220 that is suitable for use in connection with an embodiment of the invention.

In the depicted embodiment of the invention, an embedded operating system 225 interacts directly with the hardware 226 of the device 140. Operating systems are well known in the relevant arts and comprise software for functions such as, for example, controlling hardware components, managing system resources (such as memory and processing time), and managing files, among many others. An operating system 225 commonly is the most basic software that a computer executes, and it may provide a standard application program interface (“API”) 227 that all other applications on the computer rely on.

Operating systems exist that are well suited for limited-purpose devices, and such operating systems are often referred to as “embedded operating systems.” Some examples of widely available embedded operating systems, such as may be suitable for use in connection with an embodiment of the invention, are Windows® CE, VxWorks®, and embedded versions of Linux®. Versions of each of these embedded operating systems exist for the X-board COM.

The core portion or portions of the operating system 225 may be called the kernel 228. The kernel 228 may comprise routines to handle fundamental tasks, such as, e.g., memory allocation, device input and output, management of executing applications (referred to as “processes”), and/or security and user access, among others. The kernel 228 may refer to a specially adapted module, called a “device driver,” for control of a specific hardware device. In connection with an embodiment of the invention, the operating system 225 may comprise several device drivers 229, including, for example, device drivers for USB ports 230, the display 231, and input devices 232. In an embodiment of the invention, the operating system 225 may comprise a separate device driver 233 for interaction with portable electronic data storage devices that are connected to the USB 2.0 ports 149, 150 (FIG. 2).

In an embodiment of the invention, functions specific to the invention may be implemented as a control application 235. Depending on the embodiment of the invention, the control application 235 may be arranged into distinct logical subsystems, as depicted in FIG. 4. For example, a user interface subsystem 236 may comprise routines to handle user input and output, a file management subsystem 237 may comprise routines for handing files and directories on attached storage devices, a utilities subsystem 238 may comprise routines useful to other parts of the system, and/or an executive subsystem 239 may direct the functioning of the application.

The control application 235 may rely on services provided by the embedded operating system 225. For example, the control application 235 may allocate storage for a data structure (not pictured) by invoking an appropriate function comprised by the API 227 of the embedded operating system 225. Depending on the embodiment of the invention, other services may also be provided by a runtime library 240 such as may be associated with the programming language used to develop the control application 235. For example, the standard that describes the C programming language specifies that implementations of that language are to make available several standard libraries of functions. The runtime library 240 may rely on services provided by the embedded operating system 225, and, in an embodiment of the invention, the embedded operating system 225 and the runtime library 240 may offer some of the same services to applications.

In an embodiment of the invention, the device 140 may store the control application 235, the runtime library 240, and/or the embedded operating system 225 in the nonvolatile storage 178 (FIG. 3) comprised by the COM 170 (FIG. 3). The nonvolatile storage 178 (FIG. 3) may also comprise a program called a “boot loader” 241. The COM 170 (FIG. 3) and/or the nonvolatile storage 178 (FIG. 3) may be configured so that the CPU 175 (FIG. 3) automatically begins executing the boot loader 241 on startup. The boot loader 241 may comprise instructions for loading the embedded operating system 225 into volatile storage 177 (FIG. 3) and then transferring control of execution to the embedded operating system 225 when loading is complete. The embedded operating system 225 may in turn be configured to load and then start the control application 235 automatically upon startup.

The description of a software architecture 220 is meant to be illustrative and not limiting. Functions described as being performed by one or more modules, subsystems, and/or applications may in an embodiment of the invention be performed by one or more other modules, subsystems, and/or applications instead of, or in addition to, those described. An embodiment of the invention may comprise hardware components that perform functions described herein as performed by software, and the converse is also possible.

Initial storage of software in the nonvolatile storage 178 (FIG. 3) depends on facilities that will vary depending on the COM 170 (FIG. 3) that is used. For example, the COM 170 (FIG. 3) may comprise a slot or socket into which a programmed nonvolatile storage medium may be inserted during assembly of the device 140. Alternatively, the COM 170 (FIG. 3) may comprise a fixed nonvolatile storage medium, the contents of which may be set electronically. Various suitable means for storing software on nonvolatile storage media, as may be used in connection with an embodiment of the invention, are well known in the relevant arts.

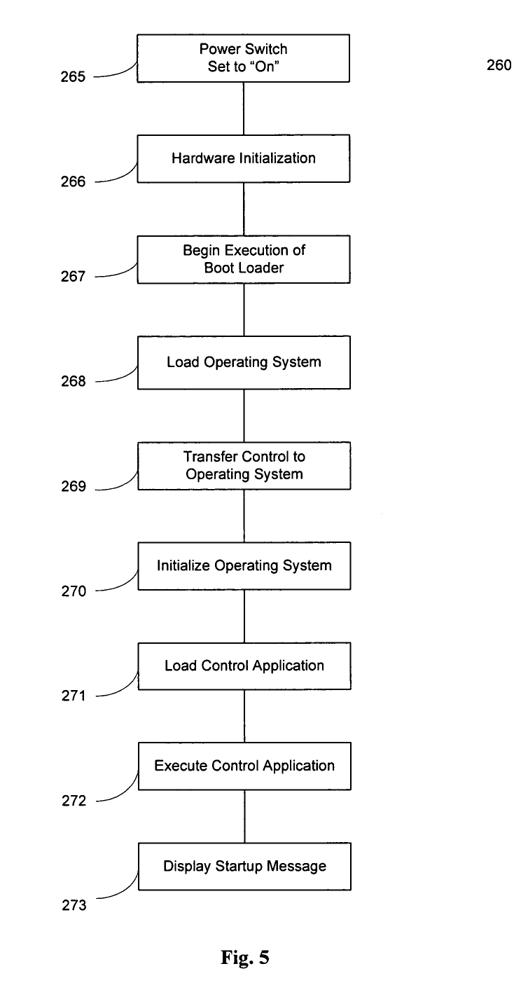

FIG. 5 further depicts startup 260 of a device according to an embodiment of the invention. Startup 260 begins at block 265 when the power switch 148 (FIG. 2) is moved to the “on” position. Hardware initialization in block 266 comprises functions that depend on the components of the device. For example, such functions may comprise a self-test of one or more components, setting one or more CPU registers to zero, and/or automatic detection of the amount of volatile and/or nonvolatile storage available, among many possibilities.

Execution of the boot loader in block 267 may comprise one or more tests of the functioning of some or all hardware. The boot loader may also load some or all of the operating system into volatile memory in block 268. As its final action, the boot loader transfers control of execution to a predetermined entry point of the operating system in block 269.

In block 270, the operating system carries out its own initialization. Depending on the operating system and the embodiment of the invention, this initialization may comprise one or more of, e.g., creating and populating one or more data structures representing the allocation of memory, creating and populating one or more data structures representing running applications, starting one or more housekeeping applications (often referred to as “daemons”), and/or loading one or more device drivers.

When the operating system has completed initialization, it loads the control application into main memory in block 271 and then begins executing the control application in block 272. The control application may create and/or initialize one or more of its own, internal data structures. The control application may also register itself with one or more facilities provided by the embedded operating system: for example, the embedded operating system may provide a facility to notify an interested application when a new storage device becomes available, and the control application may invoke a routine to indicate to the embedded operating system that it is to receive such notices. The control program may comprise one or more daemons and/or may rely on one or more services provided by one or more daemons.

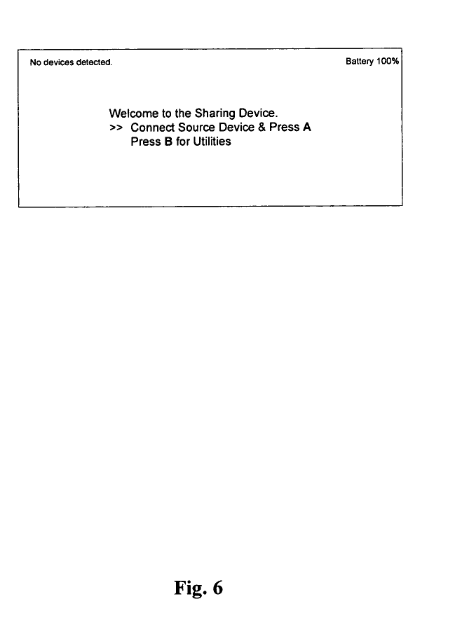

In block 273, the startup process concludes, and the control program causes an appropriate message to appear on the display 145 (FIG. 2). FIG. 6 depicts the appearance of an exemplary message according to an embodiment of the invention.

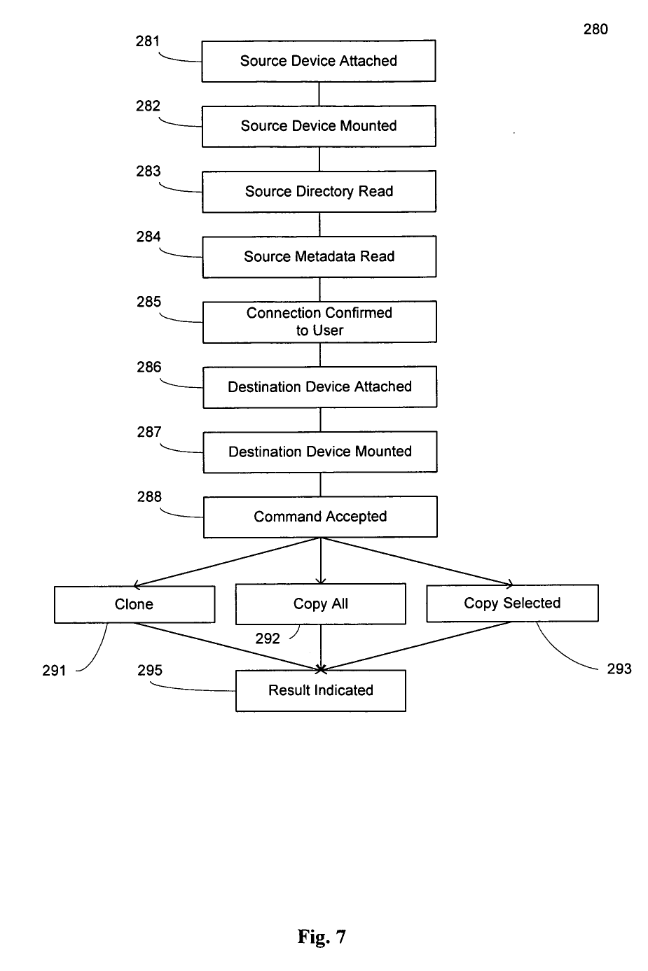

FIG. 7 depicts, at a high level, copying 280 of data from a first portable electronic data storage device to a second such device, according to an embodiment of the invention. At block 281, the first device (also referred to as the “source” device) is connected to the transfer device. In connection with an embodiment of the invention, this connection may be achieved by connecting a cable from the source device to the source USB 2.0 port 149 (FIG. 2).

As commonly seen in the art, personal media players store data as named files, with each file typically containing, e.g., a single song, video clip (including associated sound), or document. Commonly the files are logically organized into a hierarchical structure (or “tree”) of named directories (sometimes also referred to as “folders”), in which each directory may be capable of containing one or more files and/or one or more subdirectories. When such a device also may be used as an external storage device, it may store data similarly.

The stored data, associated structure, and any metadata that may be present to enable or assist management of the data and/or structure may be referred to collectively as a “file system.”

In block 282, the COM 170 (FIG. 3) detects a newly-connected source device and causes the embedded operating system to register it. Depending on the embodiment of the invention, detection of the newly-connected device my take place automatically or may require user input, e.g., through the push button 147 (FIG. 3). In an embodiment of the invention, registering the device may mean, for example, that the operating system executes routines to request directory information from one or more standard storage locations. Once such information has been received from the source device, the operating system carries out routines designed to make the data stored on the source device available to the operating system and, possibly, applications that rely on the operating system. This process is often referred to as “mounting” the file system contained on the storage device.

Block 283 depicts the functioning of the control application after it has been activated and notified that a source device has been mounted. In an embodiment of the invention, this functioning may comprise execution of one or more routines that discover the media files stored on the source device and create and/or populate one or more data structures holding information about such discovered files. Depending on the embodiment of the invention, this discovery may take place in one or more of several different ways.

For example, the application may traverse the directory tree and examine every file in turn, comparing information contained in the file and/or information about the file with stored characteristics of known types of media files. For example, sound files in the well-known MP3 format, by convention, have names that end in the characters “.mp3”. An embodiment of the invention may, therefore, store information about every file that has a name ending in that sequence of characters. Other characteristics of commonly-used types of media files are well-known to those skilled in the relevant arts.

A media player may store some or all media files and/or data about media files in one or more directories that do not appear to be mounted, are marked as “hidden”, and/or are otherwise concealed. In an embodiment of the invention, the control program is configured to locate and/or otherwise access some or all such files and/or data.

Some personal media players, such as the iPod®, maintain an internal database or databases of information associated with media files stored on a device. Such databases may comprise information, e.g., about each media file stored on the device, including, for example, the file name and location, the name of the artist, the title of the recording, and/or information associated with digital rights management, among other possibilities. Such databases may comprise other information, such as, for example, playlists and/or information about device settings. In an embodiment of the invention, the control application may retrieve information about stored media files from one or more such databases, if available, instead of or in addition to information obtained by traversing the file system. Block 284 represents the retrieval of metadata associated with media files and may take place in parallel with block 283 or in sequence with it.

The structure of one or more directories and/or the location of one or more files (including media files) may also comprise metadata retrieved in block 284.

Some well-known formats for media files may comprise metadata (e.g., the title of a recording, the name of the artist, information associated with digital rights management, etc.) describing or otherwise associated with the digital content contained in a media file. In an embodiment of the invention, block 284 may comprise retrieving some or all such metadata from one or more such files in addition to or instead of retrieval of metadata from one or more databases.

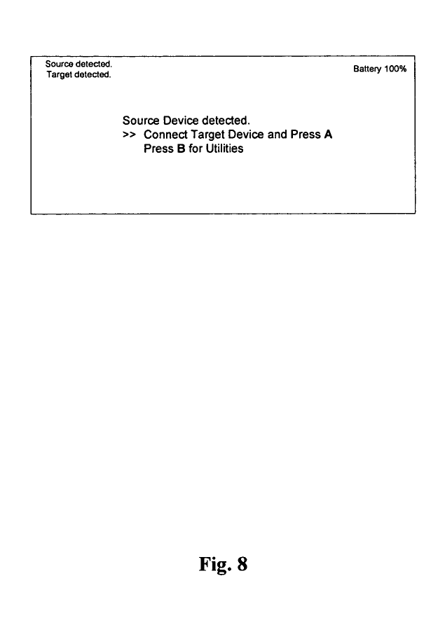

Block 285 comprises causing the display to present a message indicating that a source device has been mounted and that information has been retrieved from it. Such a message may, in an embodiment of the invention, instruct the user to connect a destination device to the transfer device. FIG. 8 depicts an example of a message that may be presented in an embodiment of the invention. In an embodiment of the invention, if data cannot be read from the source device, an alternate message (not pictured) may be presented to inform the user of an error.

Block 286 in FIG. 7 depicts attachment of the second portable electronic storage device (referred to as the “destination” device) to the transfer device. In connection with an embodiment of the invention, this connection may be achieved by connecting a cable from the destination device to the destination USB 2.0 port 150 (FIG. 2). In block 287, the COM 170 (FIG. 3) detects the newly-connected destination device, as with the source device in block 282, and the file system of the destination device may then be mounted. As with the source device, depending on the embodiment of the invention, detection of the newly-connected destination device my take place automatically or may require user input, e.g., through the push button 147 (FIG. 3).

It may be possible that a destination device may be connected successfully but may lack a file system. In such a case, in connection with an embodiment of the invention, a user may be invited to format (not pictured) the destination device, creating a new, empty file system on the destination device. Once created, the new file system is mounted as before.

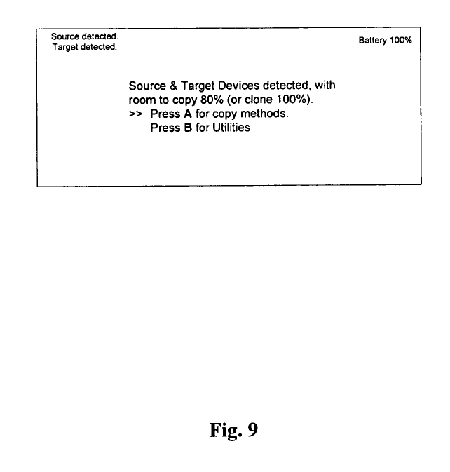

After connection of the destination device and mounting of its file system, the control application may in an embodiment of the invention cause the display to present a message to that effect and/or to present to the user one or more commands for transferring data from the source device to the destination device. FIG. 9 depicts an example of what may be presented in an embodiment of the invention. In an embodiment of the invention, if a file system cannot be mounted from the destination device, or if some other condition exists that prevents transfer of data to the destination device, an alternate message (not pictured) may be presented to inform the user of an error.

In an embodiment of the invention, when more than one command is presented, one command may be highlighted at a time, and the navigation switch 146 (FIG. 2) may be used to change the highlighted command. If more commands are available than can be accommodated at one time on the display, the navigation switch 146 (FIG. 2) may also be used to cause the presentation to scroll forward or backward.

An embodiment of the invention may comprise commands such as, e.g., to clone a source device, to copy all files from a source device to a destination device, and/or to copy only one or more selected files from a source device to a target device. Other commands may be provided in addition to or instead of some or all of these commands. Block 288 in FIG. 7 comprises selection of the currently-highlighted command by the user, possibly by, e.g., pressing the push button 147 (FIG. 2). Block 288 may also comprise detection by the control application of the selection.

Following selection, the control application attempts to carry out the selected command. As depicted in FIG. 7, this may entail cloning the source device 291, copying all files from the source device to the destination device 292, or copying only selected files 293. These operations are described in more detail below. An embodiment of the invention may comprise functions in addition to or instead of one or more of the depicted functions.

In an embodiment of the invention, the display may in block 295 present a message (not pictured) following completion of the selected command. An embodiment of the invention may, for example, comprise presentation of a message indicating that the selected operation has completed successfully and that the source device and destination device may safely be disconnected. An embodiment of the invention may comprise presentation of one or more other messages to indicate conditions other than total success, e.g., successful copying of some files or failure to copy any files, among many other possibilities.

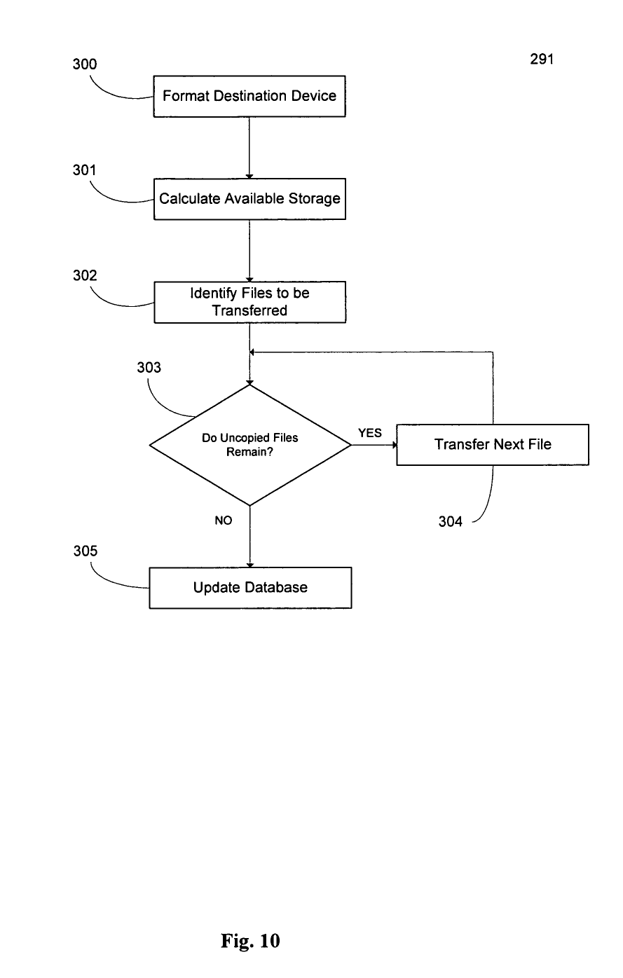

FIG. 10 depicts a clone/clone until full operation 291 according to an embodiment of the invention. This operation may be chosen when it is desired to cause the contents of the destination device to resemble those of the source device as closely as possible.

Block 300 comprises formatting the storage medium of the destination device. In an embodiment of the invention, this may comprise, e.g., invocation by the control application of one or more routines provided by the embedded operating system to delete some or all information describing any file system that exists on the destination device and/or replacing some or all such information with a description of a file system comprising only an empty directory that will be treated as the root of the hierarchy. Although the data comprised by one or more files may remain on the storage medium of the destination device, the medium will appear to applications to be empty, and such remaining data may be blindly overwritten.

To function properly—i.e., to be able to access and/or play media files and/or to perform other functions as designed by the manufacturer—a media player may require that its file system contain one or more files and/or directories and/or that a particular directory structure exist on the files system. Accordingly, in an embodiment of the invention, formatting the storage medium in block 300 may comprise creating one or more files and/or directories in the file system of the destination device, as required for the proper functioning of that device.

In block 301, the amount of storage available in the destination device is calculated. In an embodiment of the invention, this may comprise, e.g., invocation by the control application of one or more routines provided by the embedded operating system that calculate this information and return it to the invoking application.

In block 302, files are selected for copying from the source device to the destination device. In an embodiment of the invention, this may comprise, e.g., calculation by the control application of the total amount of storage required to hold the files present on the source device. If this total is less than or equal to the amount of storage available on the destination device, all files may be selected for copying. If the storage required exceeds the storage available, files may be selected based on any rule or combination of rules, which may, e.g., be specified as part of the programming of the control application. One procedure, for example, is to select files in the order in which they were discovered on the source device, selecting files until their combined sizes fill the available storage on the destination device.

As discussed above, some kinds of portable media players, such as the iPod® for example, comprise one or more databases comprising information related to the media stored thereon. Some such media players may not function properly in the absence of such databases. When used with such a player, an embodiment of the invention may take into account the size and/or estimated size of such databases in calculating the amount of storage available and in selecting the files that are to be copied.

In block 303, it is determined whether any selected files remain to be copied. If so, block 304 comprises copying the file from the source device to the destination device. In an embodiment of the invention, this may comprise, e.g., examining one or more data structures, possibly created, e.g., as in blocks 283 and/or 284 (FIG. 7). If any such media file is found, the control application may invoke one or more routines provided by the embedded operating system for copying a specified file to a specified location. The determination in block 303 may be repeated until all selected files have been copied or, alternatively, until an error condition has been detected such that the operation must be aborted.

Block 305 represents updating the database or databases, if any, on the destination device to reflect the copying of media files to the destination device. The nature of this update may depend upon one or more of the embodiment of the invention, the completeness of the copy, the nature of the database or databases, and/or other factors. For example, if the cloning operation 291 successfully copied all media files, the file or files corresponding to the database or databases may be copied in their entirety through similar means. An embodiment of the invention may, as an alternative, recreate one or more databases corresponding to the actual data copied and write one or more files representing the one or more recreated databases to the file system of the destination device. In another embodiment of the invention, one or more databases on the destination device may be continuously updated as each file is copied from the source device to the destination device. Other alternatives are possible and will be apparent to those skilled in the relevant arts.

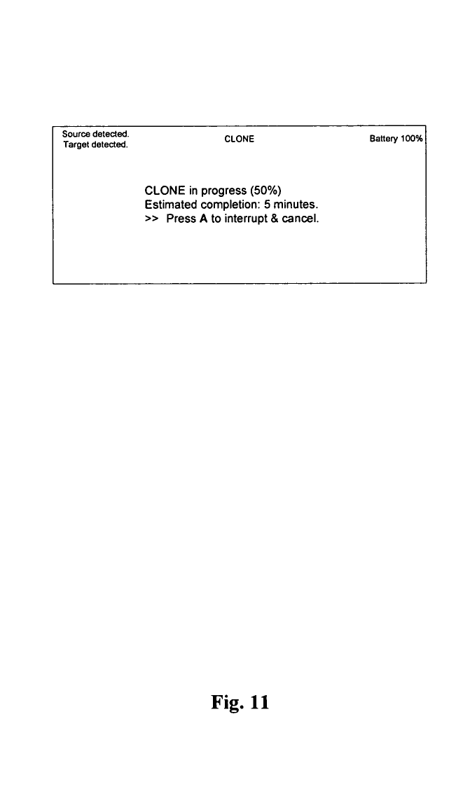

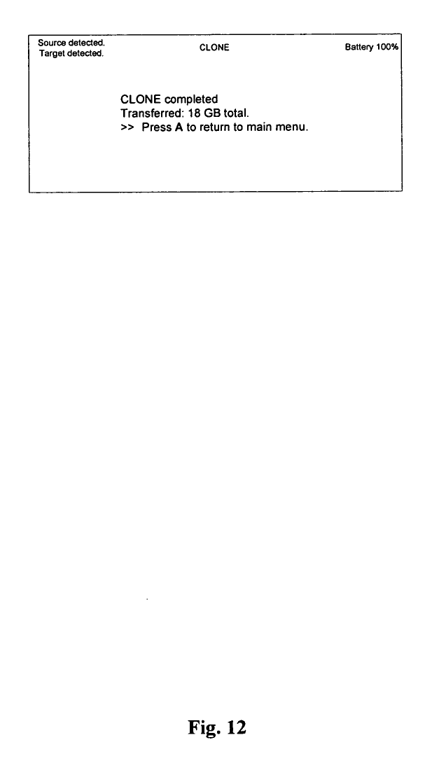

In an embodiment of the invention, the display may present information comprising, for example, an indication of the progress of the current operation. FIG. 11 depicts an example of information that may be presented in such an embodiment. FIG. 12 depicts an example of information that may be presented following successful completion of an operation, such as a cloning operation 291.

Multiple formats exist in which media files may represent data. Some of these formats are widely supported, while others, including some proprietary formats, are not. For example, nearly all media players can play audio files encoded in the MP3 format, but the newer AAC format is less widely supported, and the Apple Lossless format is supported only by iPod® models.

In an embodiment of the invention it is possible to copy media files from one model of media player to a different model of media player. In an embodiment of the invention, the different media players may come from different manufacturers and/or support different and/or incompatible formats of media files. In such an embodiment, the control application may provide the ability to convert a media file from the format in which it exists on the source device to a format compatible with the destination device. In addition to or instead of the foregoing, such an embodiment may convert some or all information (such as metadata), stored on the source device, that is associated with one or more transferred media files into a form useable by the source device.

Only the copying of media files has been discussed so far in connection with a clone operation 291, but an embodiment of the invention may comprise the capability to copy multiple file types and/or all data stored on a media player. A media player may provide functions besides data storage and media playback and may consequently store data associated with one or more such functions. For example, the iPod® comprises a date book application and a contact database. In an embodiment of the invention that comprises the capability to copy such file types, a user may be able to specify that such data is to be excluded from a clone operation 291 and/or from any other operation or operations that might otherwise copy such data.

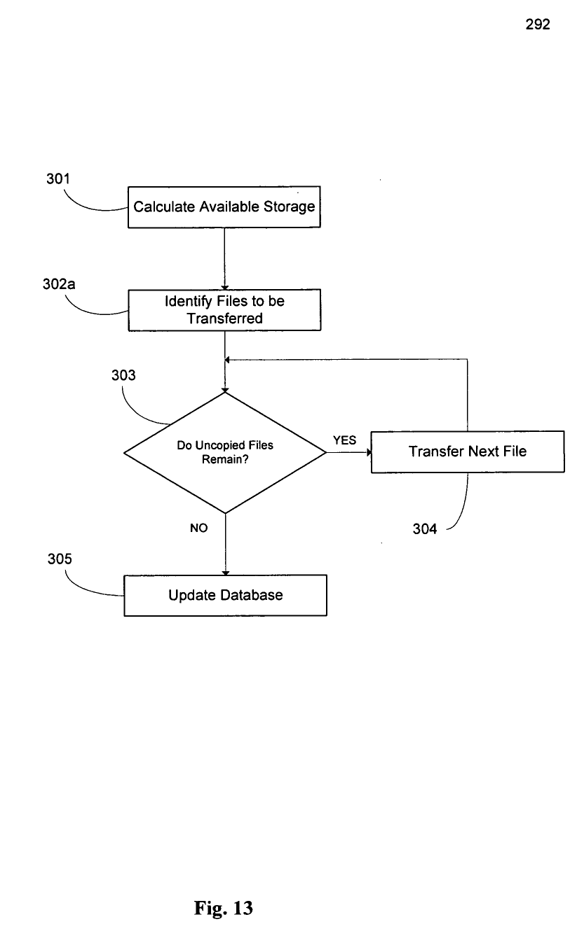

FIG. 13 depicts a copy all operation 292 according to an embodiment of the invention. As depicted, the copy all operation 292 closely resembles the cloning operation 291 (FIG. 10), but there are differences. In an embodiment of the invention, the copy all operation 292 is intended to copy the entire contents of the source device, adding that data to the data already stored on the destination device. Accordingly, the copy all operation 292 may omits erasing the destination device 300 (FIG. 10).

When the copy all operation 292 transfers media files to a destination device that already holds media files, the possibility exists that one or more files found on the source device is already present on the destination device. An embodiment of the invention may address this possibility in any of many possible ways.

An embodiment of the invention may, for example, ignore the possibility of duplicate media files altogether. In such an embodiment, a destination device may come to hold two or more copies of one or more media files. Whether this is acceptable or not may depend on the specific media player used as the destination device.

Moreover, in an embodiment that ignores duplicate files, the control application may attempt to direct the embedded operating system to write a media file to a location in the file system of the destination device where another copy of that file is already present. The consequences of such an attempt may vary depending on, among other things, the particular embedded operating system used and may comprise, e.g., ignoring the operation, overwriting the existing file with an exact duplicate, creating a copy of the existing file in the same directory such that the name of the second copy varies slightly from that of the first, and/or signaling an error condition that may or may not interrupt processing.

Instead of ignoring duplicate files, an embodiment of the invention may comprise, for example, reading information from the destination device corresponding to some or all information read from the source device in blocks 283 and/or 284 of FIG. 7. In such an embodiment, block 302a in FIG. 13 may comprise comparing the media files found on the source device with the media files found on the destination device and removing any duplicates from the list of files selected for copying. Alternatively, in such an embodiment, the copy all operation 292 may comprise deleting any duplicate files from the destination device before copying all files from the source device in blocks 303 and 304.

Many other approaches to the possibility of duplicate files will be readily apparent to those skilled in the relevant arts.

FIG. 14 depicts a copy some operation 293 according to an embodiment of the invention. As depicted, the copy some operation 293 closely resembles the copy all operation 292 (FIG. 13), and, in an embodiment of the invention, the principal difference between the two operations is that block 302b of the copy some operation comprises use of the input switches 146, 147 (FIG. 2) in conjunction with the presentation of information on the display to select one or more files to be copied to the destination device from the source device.

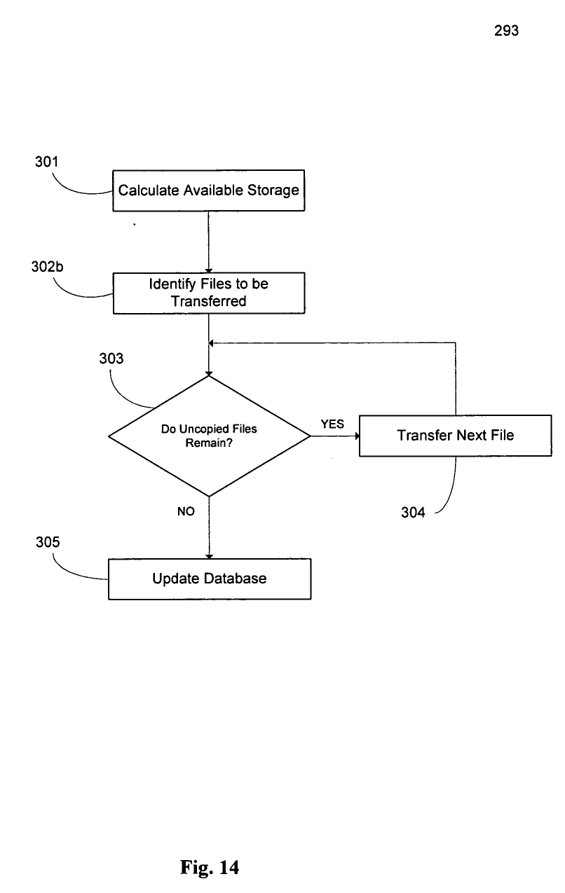

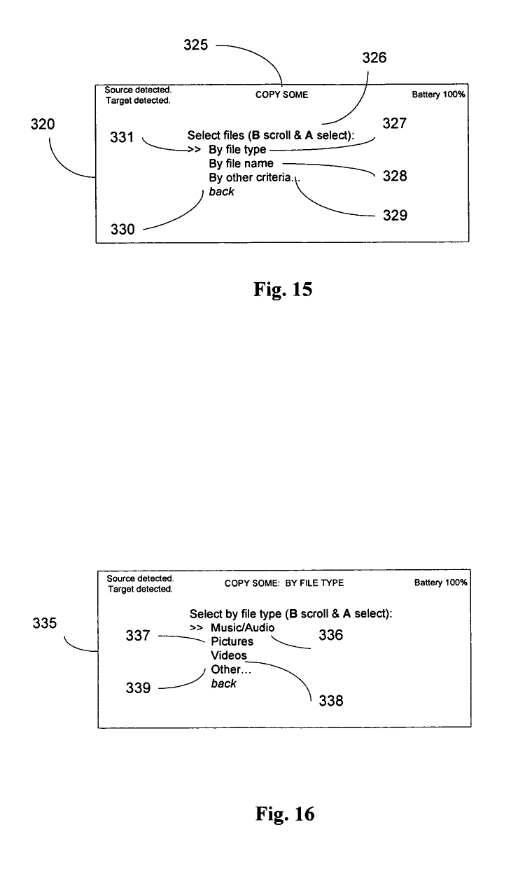

FIG. 15 depicts information 320 that may be presented on the display during file selection 302b (FIG. 14) in connection with a copy some operation 293 (FIG. 14) in an embodiment of the invention. As depicted, the information comprises a caption 325 indicating the nature of the operation and instructions 326. The information comprises options to select the criterion by which files are selected for copying, and, in an embodiment of the invention, these options may comprise, for example, selection by file type 327, by file name, 328, and by other criteria 329, which may in an embodiment of the invention be specified through use of further presented information (not pictured). An option 330 may be provided to return to the previous menu of commands.

As depicted in FIG. 15, a symbol 331 appears next to the currently selected item to indicate selection. An embodiment of the invention may comprise other visual indicia of selection in addition to or instead of the appearance of the symbol 331, such as, e.g., changing and/or inverting the colors used to display the selected item and/or otherwise presenting the selected item with an appearance contrasting with that of nonselected items. The navigation switch 146 (FIG. 2) may be used to change the current selection, and the push button 147 (FIG. 2) may be used to accept the current selection and to proceed to the next step.

FIG. 16 depicts information 335 that may be presented on the display in response to a choice to select files by file type. As depicted in FIG. 16, possible file types may comprise, for example, music (or audio) files 336, still images 337, and/or video files 338, among many possible file types. An option 339 to select other file types may be included in an embodiment of the invention, and selection of that option 339 may lead to presentation (not pictured) of other types of files for possible selection.

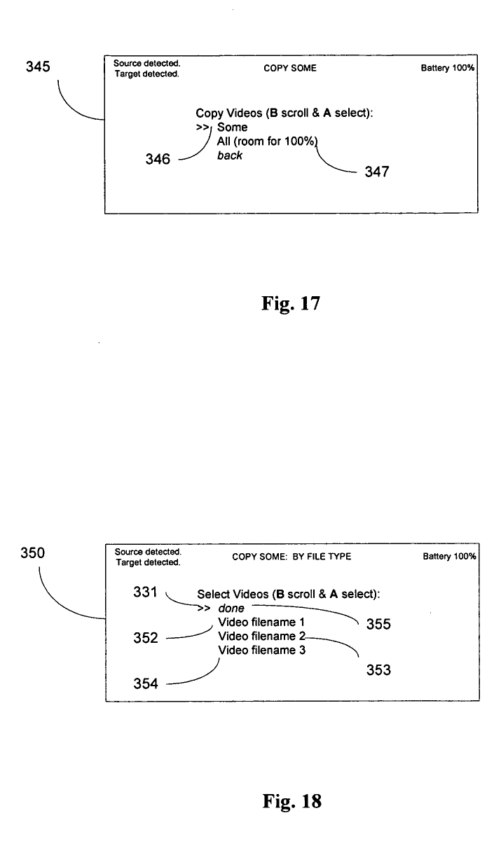

In response to the selection of a file type, information 345 as in FIG. 17 may be presented, allowing the choice of copying only some video files 346 from the source device or all of them 347. The item 347 corresponding to copying all video files may in an embodiment of the invention comprise information about the amount of storage available on the destination device and/or information about the number of files to be copied if the destination device has insufficient storage available to hold all files of the selected type.

In an embodiment of the invention, a choice to copy only some files of the selected type 346 may lead to presentation on the display of a list of individual files 352, 353, 354 for selection for copying, as depicted in FIG. 18. In an embodiment of the invention, inclusion of a file in a copy some operation 293 (FIG. 14) may be toggled with the push button 147 (FIG. 2) when the selection indicator 331 is next to a particular file. One or more visual indicia may signal the inclusion or exclusion of any particular file. If more files are available than can appear together on the display, the navigation switch 146 (FIG. 2) may be used to scroll through the list. In the depicted embodiment, copying is started by using the navigation switch 146 (FIG. 2) to move the selection indicator 331 to the item 355 labeled “done” and then using the push button 147 to accept that selection. File copying may then begin as depicted in blocks 303 and 304 of FIG. 14.

In an alternative embodiment of the invention, the display 350 comprises one or more items (not pictured) that return the user to one or more previous levels in the selection hierarchy and omit the item 355 labeled “done.” Such an embodiment may support multiple opportunities for file selection, and the item that initiates copying of selected files may be place higher in the hierarchy, e.g., with the items depicted in FIG. 15.

The preceding description of file selection is meant to be illustrative and not limiting, and an embodiment of the invention may present information and/or commands instead of or in addition to those described herein. Within a single embodiment, moreover, file selection may vary depending on the criteria and/or file type chosen. For example, a set of music files may represent songs distributed together as an album. When a user chooses to select music files, an embodiment of the invention may accordingly support selection as a unit of all music files corresponding to a single album. An embodiment of the invention may support file selection by any one or more criteria so long as appropriate information may be obtained from the source device.

In an embodiment of the invention, the control application may restrict the selection of files based on any one or more criteria. For example, a device may copy and/or restrict the user's selection of files for copying to particular kinds of files, e.g., media files, or to specific types of media and/or formats. Such restriction may further be based on one or more types of metadata such as, e.g., the kinds of metadata described elsewhere herein.

In an embodiment of the invention, a transfer device may have the ability to copy files from a source device to two or more destination devices as part of the same operation. For example, a device may have two or more destination interfaces and/or may be able to connect to multiple destination devices simultaneously through one or more hubs and/or other devices and/or techniques. In such an embodiment, the control program recognizes multiple devices, and may copy some or all selected media files identically to multiple destination devices.

An embodiment of the invention may transfer files from the source device to the destination device in addition to or instead of copying them. In this context, transferring a file comprises deleting a file from the source device after it has been stored on the destination device. In an embodiment of the application, the control program may, when transferring a file protected by a digital rights management scheme, disable the source device from accessing a file and enable the destination device to access that file, either in connection with copying or transferring the file or without copying or transferring the file in the circumstance where each device has a copy of the file.

Embodiments of the invention discussed so far have comprised a portable device for copying data from one media player to another. This discussion is intended to be illustrative, however, and not limiting, and other embodiments are possible.

For example, it is well known that the iPod® comprises a central processing unit, an operating system, and software that interacts with the operating system to provide the device's functionality. Modification of the operating system and/or software of the iPod® is also well known. Accordingly, in an embodiment of the invention, software is provided that, when installed on a compatible media player, enables the media player to copy files directly to and/or from another media player. In such an embodiment, the source and destination device may be connected to one another directly or one or more other devices, e.g., hubs, may be used to establish the connection.

We claim:

1. A method of copying electronic data comprising digitized media data from a source media player to a destination media player, comprising:
coupling a source media player to a portable transfer device, the source media player comprising a first data storage medium upon which data is stored in a file system and the stored data comprising at least one file that comprises digitized media data;
coupling a destination media player to the transfer device while the source media player is coupled to the transfer device, the destination media player comprising a second data storage medium;
selecting one or more media files that are stored on the source media player, each media file comprising digitized media data; and
using the transfer device, copying the one or more selected media files from the source media player to the destination media player.

2. The method of claim 1, comprising formatting the data storage medium of the destination media player.

3. The method of claim 2, wherein formatting the data storage medium of the destination media player comprises creating one or more additional files and/or directories on the destination media player that are required for the proper functioning of the destination media player.

4. The method of claim 1, wherein the stored data of the source media player comprises additional data associated with one or more media files, such that, for at least one media file that is associated with the additional data, some or all of the additional data is stored externally to the associated media file.

5. The method of claim 4, wherein the additional data comprises metadata.

6. The method of claim 5, comprising copying to the destination media player at least some of the additional data associated with one or more of the selected media files.

7. The method of claim 4, wherein copying comprises copying only media data, additional data that is associated with media data, and file system data.

8. A portable transfer device assembly for copying electronic data comprising digitized media data from a source media player to a destination media player, comprising:
a central processing unit;
a source interface coupled with the central processing unit and configured to couple with a source media player comprising a data storage medium upon which data is stored in a file system, the stored data comprising at least one media file that comprises digitized media data;
a destination interface coupled with the central processing unit and configured to couple with a destination media player; and
a data storage medium coupled to the central processing unit;
wherein the central processing unit is programmed to select one or more media files stored on the source media player and comprising digitized media data and to copy the one or more selected media files from the source media player to the destination media player; and
wherein the portable transfer device is of a size commensurate with or smaller than the source media player.

9. The device assembly of claim 8, wherein the central processing unit is programmed to format the data storage medium of the destination media player.

10. The device assembly of claim 9, wherein the formatting the data storage medium of the destination media player comprises creating one or more additional files and/or directories on the destination media player that are required for the proper functioning of the destination media player.

11. The device assembly of claim 8, wherein:
the stored data of the source media player comprises additional data associated with one or more media files, such that, for at least one media file that is associated with the additional data, some or all of the additional data is stored externally to the associated media file; and
the central processing unit is programmed to store on the destination media player some or all of the additional data that is associated with one or more of the copied files.

12. The device assembly of claim 11, wherein the central processing unit is programmed to copy only media data, additional data that is associated with media data, and file system data.

13. The device assembly of claim 8, wherein at least one of the source interface and the destination interface is a USB 2.0 port.

14. The device assembly of claim 8, wherein at least one of the source interface and the destination interface is a FireWire® port.

15. The device assembly of claim 8, wherein:
at least one of the source interface and the destination interface comprises a connector that is capable of coupling with an interface adapter;
the interface adapter is capable of coupling a media player to the device; and
the device is capable of being coupled at different times to a plurality of media players having mutually incompatible interfaces by coupling an adapter corresponding to an appropriate interface to the connector.

16. A system for copying electronic data comprising digitized media data from a source media player to a destination media player, comprising:
a portable transfer device for copying electronic data comprising digitized media data from a source media player to a destination media player, comprising:
a central processing unit;
a source interface coupled with the central processing unit and capable of coupling with a source media player comprising a data storage medium upon which data is stored, the stored data comprising at least one file that comprises digitized media data;
a destination interface coupled with the central processing unit and capable of coupling with a destination media player; and
a data storage medium coupled to the central processing unit; and
at least one adapter capable of coupling to the source interface and/or the destination interface, such that the source media player and/or the destination media player is capable of coupling to the transfer device when the adapter is coupled to the corresponding interface;
wherein the central processing unit is programmed to select one or more media files stored on the source media player and comprising digitized media data and to copy the one or more selected media files from the source media player to the destination media player.
